(19) United States
(12) Patent Application Publication
(10) Pub. No.: US 2026/0243827 A1
(43) Pub. Date: Aug. 20, 2026

(54) METHOD AND APPARATUS FOR CALCULATING ELECTRIC ARC RADIATION ENERGY OF ELECTRIC POWER SWITCH DEVICE, AND DEVICE

(71) Applicant: ELECTRIC POWER RESEARCH INSTITUTE, CHINA SOUTHERN POWER GRID, Guangzhou, Guangdong (CN)

(72) Inventors: Guoli WANG, Guangzhou, Guangdong (CN); Chao GAO, Guangzhou, Guangdong (CN); Fusheng ZHOU, Guangzhou, Guangdong (CN); Yao ZHENG, Guangzhou, Guangdong (CN); Ruodong HUANG, Guangzhou, Guangdong (CN); Jiaming XIONG, Guangzhou, Guangdong (CN); Yun YANG, Guangzhou, Guangdong (CN); Lei JIA, Guangzhou, Guangdong (CN); Xipeng CHEN, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 19/489,603

(22) PCT Filed: May 30, 2024
(86) PCT No.: PCT/CN2024/096269

§ 371 Date: Dec. 3, 2025

(30) Foreign Application Priority Data
Jun. 5, 2023 (CN) 202310657764.7

(51) Int. Cl. G01R 31/327

(52) U.S. Cl. CPC G01R 31/3274

(57) ABSTRACT

A method and apparatus for calculating the electric arc radiation energy of an electric power switch device, and a device. The method comprises: constructing a two-dimensional electric arc simulation model for an electric power switch device according to a fundamental equation of two-dimensional magnetohydrodynamics; performing iterative calculation in the two-dimensional electric arc simulation model according to the initial temperature and initial pressure of the electric power switch device, so as to obtain temperature data that meets iterative constraint conditions; and according to the temperature data and the electric arc radius of the electric power switch device, calculating the electric arc radiation energy of the electric power switch device. Radiation calculations of different regions of an electric arc are taken into consideration.

### CROSS REFERENCE OF RELATED APPLICATION

The present application claims priority to Chinese patent application No. 202310657764.7, titled “METHOD AND APPARATUS FOR CALCULATING ELECTRIC ARC RADIATION ENERGY OF ELECTRIC POWER SWITCH DEVICE, AND DEVICE”, filed on Jun. 5, 2023 with the China National Intellectual Property Administration, which is incorporated herein by reference in its entirety.

### FIELD

The present disclosure relates to the technical field of arcs in high-voltage circuit breakers, and in particular to a method and an apparatus for calculating arc radiation energy of an electric power switch device, and a device.

### BACKGROUND

A high-voltage circuit breaker is a critical device in an electric power system, serving to control an operation mode of the electric power system and provide fault protection. When a fault such as short circuit occurs in the electric power system, the high-voltage circuit breaker rapidly cuts off a faulty line to ensure stable operation of other parts of the electric power system. During this process, an arc is generated between arcing contacts of the high-voltage circuit breaker. Whether the arc can be extinguished smoothly and promptly is critical to the normal operation of the high-voltage circuit breaker and the reliable operation of the electric power system.

Arc simulation plays a very important role in the study of breaking characteristics of the high-voltage circuit breaker, making it essential to establish an accurate arc model. The energy of the arc originates from Joule heat generated when a current passes through the arc, and the energy dissipation of the arc mainly occurs in three mechanisms: conduction, convection, and radiation. Compared with conduction and convection, in a high-current, high-pressure gas circuit breaker, a maximum temperature of an arc reaches tens of thousands of Kelvins, where a radiation energy dissipation mechanism dominates. Therefore, establishing an arc radiation model is crucial for simulation calculation of an entire arc interruption process. A radiative transfer process in an arc is essentially the transport of photons, and is described by a radiative transfer equation ŝ·∇Iᵥ(A, ŝ)=Kᵥ(Bᵥ−Iᵥ), where Iᵥ represents a spectral radiation intensity, Kᵥ represents a spectral absorption coefficient, S represents a radiation propagation direction, and Bᵥ represents the Planck constant.

A radiation property of the arc can be obtained by solving the radiative transfer equation. However, two following issues arise in practice: first, the dependency of radiation on space and spectra makes the precise calculation of the radiation transfer equation difficult; and second, various atomic and molecular radiation mechanisms and processes are required to be considered in a process of solving the radiative transfer equation, introducing significant complexity. Therefore, accurately calculating radiation by solving the radiative transfer equation is time consuming, which is often unnecessary for industrial applications.

### SUMMARY

A method and an apparatus for calculating arc radiation energy of an electric power switch device, and a device are provided according to embodiments of the present disclosure, which aims to address a technical issue of an inaccurate arc calculation result caused by the spatial and spectral dependence of radiation in conventional circuit breakers when using conventional radiative transfer equations.

To achieve the foregoing objective, the following technical solutions are provided according to an embodiment of the present disclosure.

In an aspect, a method for calculating arc radiation energy of an electric power switch device is provided, and includes:
obtaining a structure, an arc radius, an initial temperature, and an initial pressure of the electric power switch device, and constructing, based on the structure of the electric power switch device, a two-dimensional arc simulation model in two-dimensional axisymmetric geometry by using a fundamental equation of two-dimensional magnetohydrodynamics;
performing iterative calculation in the two-dimensional arc simulation model based on the initial temperature and the initial pressure to obtain temperature data satisfying an iterative constraint condition; and
performing calculation based on the arc radius and the temperature data to obtain first radiation energy of an arc core region and second radiation energy of an arc edge region in the electric power switch device.

In an embodiment, the performing calculation based on the arc radius and the temperature data to obtain first radiation energy of an arc core region and second radiation energy of an arc edge region in the electric power switch device includes:
performing calculation by using an arc radiation energy calculation equation based on the arc radius and the temperature data to obtain the first radiation energy of the arc core region and the second radiation energy of the arc edge region in the electric power switch device, where the arc radiation energy calculation equation is expressed as

$${U}_{0} ( T ) = \frac{2 β {T}^{4}}{R}$$

$$U = {U}_{0} ( T ) K$$

where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

In an embodiment, the reduced pressure coefficient is calculated based on an actual pressure at a position of the arc edge region of the electric power switch device and a pressure at a position of the arc core region of the electric power switch device, and the reduced pressure coefficient is not greater than 1.

In an embodiment, the performing iterative calculation in the two-dimensional arc simulation model based on the initial temperature and the initial pressure to obtain temperature data satisfying an iterative constraint condition includes:
inputting the initial temperature and the initial pressure into the two-dimensional arc simulation model for calculation to obtain a first pressure of the electric power switch device and an enthalpy value corresponding to the first pressure; and
back-calculating a post-iteration temperature by using a relation equation between temperature and enthalpy h in the two-dimensional arc simulation model;
continuing the iterative calculation until a temperature difference between two temperatures respectively obtained from two adjacent iterative calculations satisfies the iterative constraint condition, and determining a temperature obtained from a last iterative calculation as the temperature data satisfying the iterative constraint condition, where
the iterative constraint condition is that the temperature difference is less than a threshold, and the relation equation between temperature and enthalpy h is expressed as

$${{C}_{P} = \frac{\partial h}{\partial T} \vert}_{P}$$

where C_{P} represents a relationship coefficient between the temperature and the enthalpy h, h represents the enthalpy value corresponding to the first pressure, P represents a pressure for the iterative calculation in the two-dimensional arc simulation model, and T represents the temperature data.

In an embodiment, the electric power switch device is implemented by a puffer-type high-voltage circuit breaker or a self-energy high-voltage circuit breaker.

In another aspect, an apparatus for calculating arc radiation energy of an electric power switch device is provided, and includes: a model construction module, an iterative calculation module, and an energy calculation module.

The model construction module is configured to obtain a structure, an arc radius, an initial temperature, and an initial pressure of the electric power switch device, and construct, based on the structure of the electric power switch device, a two-dimensional arc simulation model in two-dimensional axisymmetric geometry by using a fundamental equation of two-dimensional magnetohydrodynamics.

The iterative calculation module is configured to perform iterative calculation in the two-dimensional arc simulation model based on the initial temperature and the initial pressure to obtain temperature data satisfying an iterative constraint condition.

The energy calculation module is configured to perform calculation based on the arc radius and the temperature data to obtain first radiation energy of an arc core region and second radiation energy of an arc edge region in the electric power switch device.

In an embodiment, the energy calculation module is configured to perform calculation by using an arc radiation energy calculation equation based on the arc radius and the temperature data to obtain the first radiation energy of the arc core region and the second radiation energy of the arc edge region in the electric power switch device, where the arc radiation energy calculation equation is expressed as:

$${U}_{0} ( T ) = \frac{2 β {T}^{4}}{R}$$

$$U = {U}_{0} ( T ) K$$

where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

In an embodiment, the reduced pressure coefficient is calculated based on an actual pressure at a position of the arc edge region of the electric power switch device and a pressure at a position of the arc core region of the electric power switch device, and the reduced pressure coefficient is not greater than 1.

In an embodiment, the iterative calculation module includes: an enthalpy value determination submodule and a temperature data determination submodule.

The enthalpy value determination submodule is configured to input the initial temperature and the initial pressure into the two-dimensional arc simulation model for calculation to obtain a first pressure of the electric power switch device and an enthalpy value corresponding to the first pressure.

The temperature data determination submodule is configured to back-calculate a post-iteration temperature by using a relation equation between temperature and enthalpy h in the two-dimensional arc simulation model, continue the iterative calculation until a temperature difference between two temperatures respectively obtained from two adjacent iterative calculations satisfies the iterative constraint condition, and determine a temperature obtained from a last iterative calculation as the temperature data satisfying the iterative constraint condition.

The iterative constraint condition is that the temperature difference is less than a threshold, and the relation equation between temperature and enthalpy h is expressed as

$${{C}_{P} = \frac{\partial h}{\partial T} \vert}_{P}$$

where C_{P} represents a relationship coefficient between the temperature and the enthalpy h, h represents an enthalpy value corresponding to the first pressure, P represents a pressure for the iterative calculation in the two-dimensional arc simulation model, and T represents the temperature data.

In another aspect, a terminal device is provided, and the terminal device includes a processor and a memory.

The memory is configured to store program codes and transmit the program codes to the processor.

The processor is configured to, when executing instructions in the program codes, perform the method for calculating the arc radiation energy of the electric power switch device described above.

From the above technical solutions, the method and the apparatus for calculating the arc radiation energy in the electric power switch device and the device are provided according to the embodiments of the present disclosure, and the technical solutions have the following advantages.

The method includes: obtaining a structure, an arc radius, an initial temperature, and an initial pressure of the electric power switch device, and constructing, based on the structure of the electric power switch device, a two-dimensional arc simulation model in two-dimensional axisymmetric geometry by using a fundamental equation of two-dimensional magnetohydrodynamics; performing iterative calculation in the two-dimensional arc simulation model based on the initial temperature and the initial pressure to obtain temperature data satisfying an iterative constraint condition; and performing calculation based on the arc radius and the temperature data to obtain first radiation energy of an arc core region and second radiation energy of an arc edge region in the electric power switch device. With the method for calculating the arc radiation energy of the electric power switch device, the two-dimensional arc simulation model for the electric power switch device is constructed by using the fundamental equation of two-dimensional magnetohydrodynamics. Iterative calculation is performed in the two-dimensional arc simulation model based on the initial temperature and the initial pressure of the electric power switch device to obtain the temperature data satisfying the iterative constraint condition. The arc radiation energy of the electric power switch device is calculated based on the temperature data and the arc radius of the electric power switch device. Radiation calculation is performed considering arc in different regions, such that the calculated radiation energy result has a high accuracy and a rationality in terms of physical mechanism. According to the method, the need to solve the radiative transfer equation is eliminated, significantly reducing calculation time and enhancing efficiency, which is more suitable for arc simulation calculation in the field of electric power industry. The technical issue of an inaccurate arc calculation result caused by the spatial and spectral dependence of radiation in conventional circuit breakers when using conventional radiative transfer equations is addressed.

### BRIEF DESCRIPTION OF THE DRAWINGS

For clearer illustration of the technical solutions according to embodiments of the present disclosure or conventional technology, drawings to be used in description of the present disclosure or conventional technology are briefly described hereinafter. Apparently, the drawings in the following descriptions are only some embodiments of the present disclosure, and other drawings may be obtained by those skilled in the art based on the provided drawings without any creative effort.

FIG. 1 is a flowchart illustrating steps of a method for calculating arc radiation energy of an electric power switch device according to an embodiment of the present disclosure;

FIG. 2 is a schematic diagram of an arc morphology of an electric power switch device in a method for calculating arc radiation energy of the electric power switch device according to an embodiment of the present disclosure;

FIG. 3 is a schematic diagram of arc energy distribution of an electric power switch device in a method for calculating arc radiation energy of the electric power switch device according to an embodiment of the present disclosure;

FIG. 4 is a graph of an axial distribution of a temperature and a pressure of the arc at a time instant during arcing, simulated by a two-dimensional arc simulation model based on a method for calculating arc radiation energy of an electric power switch device according to an embodiment of the present disclosure; and

FIG. 5 is a block diagram of an apparatus for calculating arc radiation energy of an electric power switch device according to an embodiment of the present disclosure.

### DETAILED DESCRIPTION OF THE EMBODIMENTS

In order to make the objectives, features, and advantages of the present disclosure clearer and more comprehensible, the technical solutions in the embodiments of the present disclosure are clearly and completely described below with reference to the drawings in the embodiments of the present disclosure. Apparently, the embodiments described below are merely a part rather than all of the embodiments of the present disclosure. All other embodiments obtained by those skilled in the art based on the embodiments in the present disclosure without any creative work fall into the protection scope of the present disclosure.

In the description of the embodiments of the present disclosure, the terms “first” and “second” are used for descriptive purposes only, and should not be understood as indicating or implying relative importance or implicitly indicating the number of indicated technical features. Therefore, the features defined by “first” and “second” may explicitly or implicitly include one or more of the features. In the description of the embodiment of the present disclosure, the meaning of “multiple” is two or more, unless specifically defined otherwise.

In the present disclosure, unless otherwise explicitly specified and defined, terms such as “mount”, “link”, “connect”, and “fix” should be understood in a broad sense. For example, the terms may imply a fixed connection, a detachable connection, or an integral connection; a mechanical connection, or an electrical connection; a direct connection or an indirect connection through an intermediate media; and an internal connection between two elements or an interaction relationship between the two elements. For those skilled in the art, the specific meanings of the terms in the embodiments of the present disclosure may be understood based on specific situations.

A method and an apparatus for calculating arc radiation energy of an electric power switch device, and a device are provided according to embodiments of the present disclosure, which aims to address a technical issue of an inaccurate arc calculation result caused by the spatial and spectral dependence of radiation in conventional circuit breakers when using conventional radiative transfer equations. The method and an apparatus for calculating the arc radiation energy of the electric power switch device, and the device are applicable to the electric power switch device such as a puffer-type high-voltage circuit breaker and a self-energy high-voltage circuit breaker.

### First Embodiment

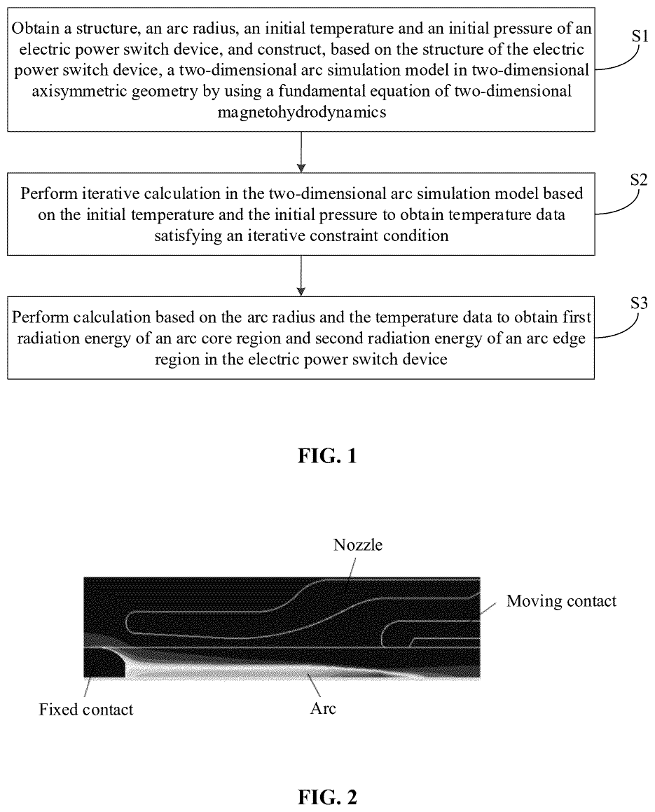

FIG. 1 is a flowchart illustrating steps of a method for calculating arc radiation energy of an electric power switch device according to an embodiment of the present disclosure. FIG. 2 is a schematic diagram of an arc morphology of the electric power switch device in the method for calculating the arc radiation energy of the electric power switch device according to an embodiment of the present disclosure. FIG. 3 is a schematic diagram of arc energy distribution of the electric power switch device in the method for calculating the arc radiation energy of the electric power switch device according to an embodiment of the present disclosure.

As shown in FIG. 1 and FIG. 2, a method for calculating arc radiation energy of an electric power switch device is provided according to an embodiment of the present disclosure, and the method includes following steps S1 to S3.

In step S1, a structure, an arc radius, an initial temperature, and an initial pressure of the electric power switch device are obtained, and based on the structure of the electric power switch device, a two-dimensional arc simulation model in two-dimensional axisymmetric geometry is constructed by using a fundamental equation of two-dimensional magnetohydrodynamics.

It should be noted that the electric power switch device may be implemented by a puffer-type high-voltage circuit breaker or a self-energy high-voltage circuit breaker. In step S1, parameters of the electric power switch device are obtained firstly. The parameters include data such as the structure, arc radius, initial temperature, and initial pressure of the electric power switch device. A two-dimensional arc simulation model in two-dimensional axisymmetric geometry is constructed based on the structure of the electric power switch device and the fundamental equation of two-dimensional magnetohydrodynamics. In the embodiment, in the method for calculating the arc radiation energy of the electric power switch device, the construction of the two-dimensional arc simulation model is performed by utilizing Gambit software based on the structure of the electric power switch device. The Gambit software is a software package designed to assist analysts and designers in building and meshing a computational fluid dynamics (CFD) model and for other scientific applications. In the constructed two-dimensional arc simulation model, the arcing process of the electric power switch device is simulated under an alternating current operating condition with an amplitude of 31.5 kA at 50 Hz. The arc morphology is shown in FIG. 2.

In the embodiment of the present disclosure, in a case that the arc in the electric power switch device is axisymmetric and axial radiation is negligible, only arc radiation in a radial direction is considered. The process of arc radiation is divided into two parts as shown in FIG. 3. A first part is arc radiation in an arc core region, where the arc core region is a region close to an arc core. The temperature in the arc core region is high and the arc may be assumed to be in an approximate blackbody state. A second part is arc radiation in an arc edge region, and radiation effects of the arc edge region are weaker. Hence, the blackbody radiation law is not applicable. Significant temperature and pressure gradients at the arc edge are taken into account.

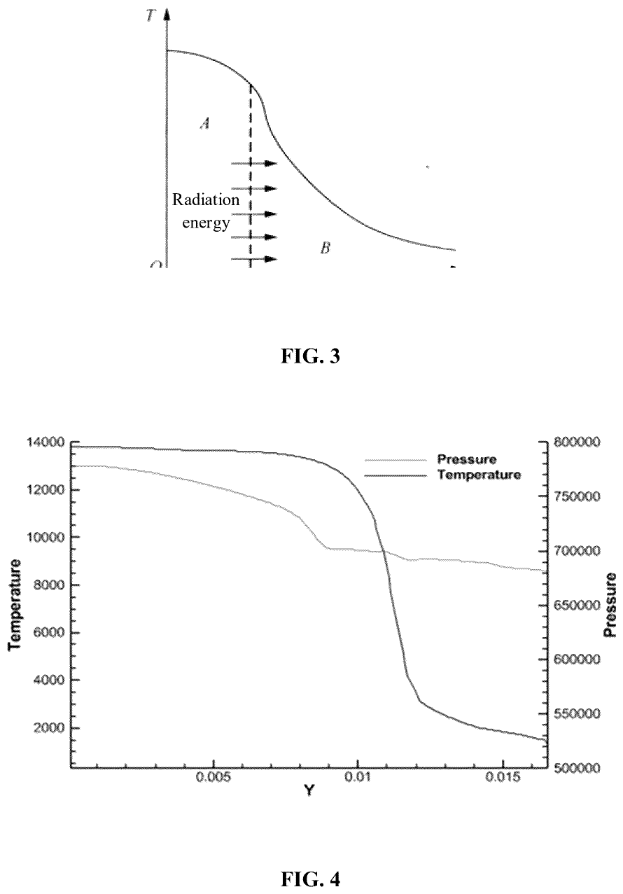

FIG. 4 is a graph of an axial distribution of a temperature and a pressure of the arc at a time instant during arcing, simulated by a two-dimensional arc simulation model based on a method for calculating arc radiation energy of an electric power switch device according to an embodiment of the present disclosure.

In the embodiment of the present disclosure, the constructed two-dimensional arc simulation model, which is based on a given geometric model structure of the electric power switch device, is employed. Using the initial temperature and the initial pressure as input parameters to the two-dimensional arc simulation model, axial distribution of a first arc temperature and a first pressure at the onset of arcing of the electric power switch device is obtained through simulation, as shown in FIG. 4. Based on the first arc temperature and the first pressure at the onset of arcing, the arc radiation is calculated. The fundamental equation of the two-dimensional magnetohydrodynamics includes the following equations.

Mass conservation equation is expressed as follows:

$$\frac{\partial p}{\partial t} + ∇ \cdot ( ρ \overline{V} ) = 0$$

Axial momentum conservation equation is expressed as follows:

$$\frac{\partial ( ρ ω )}{\partial t} + ∇ \cdot ( ρ \overline{V} ω ) - ∇ \cdot ( ( {μ}_{l} + {μ}_{t} ) ∇ ω ) = - \frac{\partial P}{\partial z} + ∇ \cdot {τ}^{=} + {J}_{r} {B}_{θ}$$

Radial momentum conservation equation is expressed as follows:

$$\frac{\partial ( ρ v )}{\partial t} + ∇ \cdot ( ρ \overline{V} v ) - ∇ \cdot ( ( {μ}_{l} + {μ}_{t} ) ∇ v ) = - \frac{\partial p}{\partial r} + ∇ \cdot \overline{τ} + {J}_{z} {B}_{θ}$$

Energy conservation equation is expressed as follows:

$$\frac{\partial ( ρ h )}{\partial t} + ∇ \cdot ( ρ \overline{V} h ) - ∇ \cdot ( \frac{{k}_{l} + {k}_{t}}{{c}_{p}} ∇ h ) = ∇ \cdot ( \overline{τ} \cdot \overline{V} ) + σ {E}^{2} - U$$

Electromagnetic field equation is expressed as follows:

$$∇ \cdot ( σ ∇ φ ) = 0$$

$$\frac{1}{r} \frac{\partial }{\partial r} ( {rB}_{θ} ) = {μ}_{θ} {J}_{z}$$

In the equations, z represents an axial direction, r represents a radial direction, θ represents an azimuthal direction, t represents time/s, ρ represents density/kg·m⁻³, \vec{V} represents a velocity vector, v represents radial velocity/m·s⁻¹, ω represents axial velocity/m·s⁻¹, μₗ represents laminar viscosity/kg·m⁻¹·s⁻¹, μₜ represents turbulent viscosity/kg·m⁻¹·s⁻¹, kₗ represents laminar thermal conductivity/W m⁻¹·K⁻¹, kₜ represents turbulent thermal conductivity/W·m⁻¹·K⁻¹, U represents radiant energy/J·m⁻³, h represents an enthalpy value/J·kg⁻¹, cₚ represents specific heat at constant pressure/J·kg⁻¹·K⁻¹, p represents atmospheric pressure/Pa, σ represents electrical conductivity/W·m⁻¹, Φ represents electric potential/V, B_{θ} represents an azimuthal component of magnetic flux density/T·m⁻¹, J_{z} represents an axial current density/A·m⁻², Jᵣ represents an radial current density/A·m⁻², μ₀ represents vacuum permeability/H·m⁻¹, ∇·τ̅ represents a viscous term, ∇·(τ̅·\vec{V}) represents a viscous diffusion term, mₐ represents an ablation rate/kg·s⁻¹, v_{d} represents an ablation vapor incidence velocity/m·s⁻¹, and hₐ represents an ablation vapor enthalpy value/J·kg⁻¹.

In step S2, iterative calculation is performed in the two-dimensional arc simulation model based on the initial temperature and the initial pressure to obtain temperature data satisfying an iterative constraint condition.

It should be noted that in step S2, iterative calculation is performed by using the two-dimensional arc simulation model constructed in step S1 based on the initial temperature and the initial pressure obtained in step S1 to calculate the temperature data satisfying an iterative constraint condition.

In the embodiment of the present disclosure, the performing iterative calculation in the two-dimensional arc simulation model based on the initial temperature and the initial pressure to obtain temperature data satisfying an iterative constraint condition includes:
inputting the initial temperature and the initial pressure into the two-dimensional arc simulation model for calculation to obtain a first pressure of the electric power switch device and an enthalpy value corresponding to the first pressure; and
back-calculating a post-iteration temperature by using a relation equation between temperature and enthalpy h in the two-dimensional arc simulation model; and
continuing the iterative calculation until a temperature difference between two temperatures respectively obtained from two adjacent iterative calculations satisfies the iterative constraint condition, and determining a temperature obtained from a last iterative calculation as the temperature data satisfying the iterative constraint condition.

The iterative constraint condition is that the temperature difference is less than a threshold, and the relation equation between temperature and enthalpy h is expressed as

$${{C}_{P} = \frac{\partial h}{\partial T} \vert}_{P}$$

where C_{P} represents a relationship coefficient between the temperature and the enthalpy h, h represent the enthalpy value corresponding to the first pressure, P represents a pressure for the iterative calculation in the two-dimensional arc simulation model, and T represents the temperature data.

It should be noted that the threshold may be 1e⁻⁶, and determination is performed between the temperature difference obtained after each iteration and the threshold. The temperature difference is a difference between a currently calculated temperature and a temperature calculated in a previous iteration. Iteration may be performed based on the initial pressure by using the momentum conservation equation, and the pressure after one iteration is obtained. For temperature, a relationship between temperature and enthalpy h is first established through the relation equation between the temperature and the enthalpy h, a new enthalpy value is obtained after one iteration (the iteration depends on the governing equation on the left side), and then according to the relationship, the post-iteration temperature is back-calculated based on the enthalpy value. In the embodiment, the threshold data may be set as required.

In step S3, calculation is performed based on the arc radius and the temperature data to obtain first radiation energy of an arc core region and second radiation energy of an arc edge region in the electric power switch device.

It should be noted that in step S3, the first radiation energy of the arc core region and the second radiation energy of the arc edge region in the electric power switch device are calculated based on the temperature data calculated in step S2 and the arc radius obtained in step S1, and the calculated first radiation energy and the second radiation energy are the arc simulation calculation results of the arc radiation process. The method for calculating the arc radiation energy of the electric power switch device is highly efficient, and calculation in the entire embodiment takes only 30 minutes through computer software.

The method for calculating the arc radiation energy of the electric power switch device is provided according to the present disclosure, and the method includes: obtaining a structure, an arc radius, an initial temperature, and an initial pressure of the electric power switch device, and constructing, based on the structure of the electric power switch device, a two-dimensional arc simulation model in two-dimensional axisymmetric geometry by using a fundamental equation of two-dimensional magnetohydrodynamics; performing iterative calculation in the two-dimensional arc simulation model based on the initial temperature and the initial pressure to obtain temperature data satisfying an iterative constraint condition; and performing calculation based on the arc radius and the temperature data to obtain first radiation energy of an arc core region and second radiation energy of an arc edge region in the electric power switch device. With the method for calculating the arc radiation energy of the electric power switch device, the two-dimensional arc simulation model for the electric power switch device is constructed by using the fundamental equation of two-dimensional magnetohydrodynamics. Iterative calculation is performed in the two-dimensional arc simulation model based on the initial temperature and the initial pressure of the electric power switch device to obtain the temperature data satisfying the iterative constraint condition. The arc radiation energy of the electric power switch device is calculated based on the temperature data and the arc radius of the electric power switch device. Radiation calculation is performed considering arc in different regions, such that the calculated radiation energy result has a high accuracy and a rationality in terms of physical mechanism. According to the method, the need to solve the radiative transfer equation is eliminated, significantly reducing calculation time and enhancing efficiency, which is more suitable for arc simulation calculation in the field of electric power industry. The technical issue of an inaccurate arc calculation result caused by the spatial and spectral dependence of radiation in conventional circuit breakers when using conventional radiative transfer equations is addressed.

In an embodiment of the present disclosure, the performing calculation based on the arc radius and the temperature data to obtain first radiation energy of an arc core region and second radiation energy of an arc edge region in the electric power switch device includes:
performing calculation by using an arc radiation energy calculation equation based on the arc radius and the temperature data to obtain the first radiation energy of the arc core region and the second radiation energy of the arc edge region in the electric power switch device, where the arc radiation energy calculation equation is expressed as

$${U}_{0} ( T ) = \frac{2 β {T}^{4}}{R}$$

$$U = {U}_{0} ( T ) K$$

where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

It should be noted that the first radiation energy of the arc core region in the electric power switch device is calculated by using the Stefan-Boltzmann law, which states that a total power radiated per unit area of the arc surface in the arc core region is proportional to a fourth power of a thermodynamic temperature T of the arc surface. The radiation of the arc edge region in the electric power switch device is considered proportional to the reduced pressure coefficient.

In the embodiment of the present disclosure, the reduced pressure coefficient is calculated based on an actual pressure at a position of the arc edge region of the electric power switch device and a pressure at a position of the arc core region of the electric power switch device, and the reduced pressure coefficient is not greater than 1.

It should be noted that since the temperature in the arc edge region is low, the pressure in the arc edge region is lower than the pressure in the arc core region, such that the reduced pressure coefficient is less than or equal to 1. Since the pressure within the electric power switch device reflects mass density of an arc and the radiation process is closely related to the density, a weak radiation process in the arc edge region may be approximately simulated by using an arc radiation energy calculation equation.

### Second Embodiment

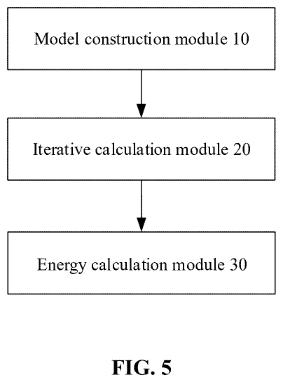

FIG. 5 is a block diagram of an apparatus for calculating arc radiation energy of an electric power switch device according to an embodiment of the present disclosure.

As shown in FIG. 5, an apparatus for calculating arc radiation energy of an electric power switch device is provided according to an embodiment of the present disclosure. The apparatus includes a model construction module 10, an iterative calculation module 20, and an energy calculation module 30.

The model construction module 10 is configured to obtain a structure, an arc radius, an initial temperature, and an initial pressure of the electric power switch device, and construct, based on the structure of the electric power switch device, a two-dimensional arc simulation model in two-dimensional axisymmetric geometry by using a fundamental equation of two-dimensional magnetohydrodynamics.

The iterative calculation module 20 is configured to perform iterative calculation in the two-dimensional arc simulation model based on the initial temperature and the initial pressure to obtain temperature data satisfying an iterative constraint condition.

The energy calculation module 30 is configured to perform calculation based on the arc radius and the temperature data to obtain first radiation energy of an arc core region and second radiation energy of an arc edge region in the electric power switch device.

In the embodiment of the present disclosure, the energy calculation module 30 is configured to perform calculation by using an arc radiation energy calculation equation based on the arc radius and the temperature data to obtain the first radiation energy of the arc core region and the second radiation energy of the arc edge region in the electric power switch device, where the arc radiation energy calculation equation is expressed as

$${U}_{0} ( T ) = \frac{2 β {T}^{4}}{R}$$

$$U = {U}_{0} ( T ) K$$

where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

In the embodiment of the present disclosure, the reduced pressure coefficient is calculated based on an actual pressure at a position of the arc edge region of the electric power switch device and a pressure at a position of the arc core region of the electric power switch device, and the reduced pressure coefficient is not greater than 1.

In the embodiment of the present disclosure, the iterative calculation module 20 includes an enthalpy value determination submodule and a temperature data determination submodule.

The enthalpy value determination submodule is configured to input the initial temperature and the initial pressure into the two-dimensional arc simulation model for calculation to obtain a first pressure of the electric power switch device and an enthalpy value corresponding to the first pressure.

The temperature data determination submodule is configured to back-calculate a post-iteration temperature by using a relation equation between temperature and enthalpy h in the two-dimensional arc simulation model, continue the iterative calculation until a temperature difference between two temperatures respectively obtained from two adjacent iterative calculations satisfies the iterative constraint condition, and determine a temperature obtained from a last iterative calculation as the temperature data satisfying the iterative constraint condition.

The iterative constraint condition is that the temperature difference is less than a threshold, and the relation equation between temperature and enthalpy h is expressed as

$${{C}_{P} = \frac{\partial h}{\partial T} \vert}_{P}$$

where C_{P} represents a relationship coefficient between the temperature and the enthalpy h, h represent the enthalpy value corresponding to the first pressure, P represents a pressure for the iterative calculation in the two-dimensional arc simulation model, and T represents the temperature data.

It should be noted that the functionality of the modules within the apparatus for calculating the arc radiation energy of the electric power switch device corresponds to the steps of the method in the first embodiment. Since the steps of the method in the first embodiment have already been described in the first embodiment, the details of the modules in the second embodiment will not be described repeatedly in the embodiment.

### Third Embodiment

A terminal device is provided according to an embodiment of the present disclosure, and the terminal device includes a processor and a memory.

The memory is configured to store program codes and transmit the program codes to the processor.

The processor is configured to, when executing instructions in the program codes, perform the method for calculating the arc radiation energy of the electric power switch device described above.

It should be noted that the processor is configured to, when executing instructions in the program codes, perform the steps of the method for calculating arc radiation energy of the electric power switch device in the embodiments described above. Alternatively, the processor, when executing a computer program, implements the function of each module/unit in any foregoing system/apparatus embodiments.

As an example, the computer program may be partitioned into one or more modules/units, and the one or more modules/units are stored in the memory and are executed by the processor to implement the present disclosure. The one or more modules/units may be a series of computer program instruction segments capable of implementing specific functions. The instruction segments describe execution of the computer program in the terminal device.

The terminal device may be a computing device, such as a desktop computer, a laptop, a palmtop, or a cloud server. The terminal device may include, but is not limited to, a processor and a memory. Those skilled in the art can understand that this does not constitute a limitation on the terminal device. The terminal device may include more or fewer components than those shown in the figure, or a combination of some components, or different components. For example, the terminal device may further include input and output devices, a network access device, a bus, and the like.

The processor may be a central processing unit (CPU), a general-purpose processor, a digital signal processor (DSP), an application specific integrated circuit (ASIC), a field-programmable gate array (FPGA), or other programmable logic devices, a discrete gate, a transistor logic device, a discrete hardware component, etc. The general-purpose processor may be a microprocessor or any conventional processor.

The memory may be an internal storage unit of a terminal device, such as a hard disk or a memory of the terminal device. The memory may be an external storage device of the terminal device, such as a plug-in hard disk, a smart memory card (SMC), a secure digital (SD) card, or a flash card disposed on the terminal device. Furthermore, the memory may include both the internal storage unit of the terminal device and the external storage device. The memory is configured to store the computer program and other programs and data required by the terminal device. The memory may further used for the temporary storage of data that has been output or is to be output.

Those skilled in the art may clearly understand that, for convenience and brevity of description, for a detailed operation process of the foregoing system, apparatus and unit, reference may be made to a corresponding process in the foregoing method embodiment, which is not repeated herein.

It should be noted that, in some embodiments of the present disclosure, the disclosed system, apparatus, or method may be implemented in another manner. For example, the apparatus embodiment described above is only schematic. For example, the division of the units is only a logical functional division, and there may be other division methods in actual implementation. For example, multiple units or components may be combined or integrated into another system, or some features may be ignored or not be executed. In addition, the mutual couplings or direct couplings or communication connections shown or discussed above may be indirect couplings or communication connections through some interfaces, apparatuses or units, and may be in electrical, mechanical or other forms.

The unit described as a separate component may be or may be not separated physically. The component displayed as a unit may be or may be not a physical unit, that is, may be located at one place or may be distributed on multiple network units. Some or all of the units may be selected according to actual needs to achieve the objectives of the solutions of the embodiments.

In addition, the functional units in the embodiments of the present disclosure may be integrated into one processing unit, or each of the units may exist alone physically, or two or more of the units may be integrated into one unit. The above integrated units may be implemented in a form of hardware or software functional units.

In a case that the integrated unit is implemented in the form of software function unit and is sold or used as a separate product, it may be stored in a computer readable storage medium. Based on such an understanding, the technical solutions of the present disclosure essentially, or the part contributing to the conventional technology, or all or a part of the technical solutions may be implemented in the form of a software product. The computer software product is stored in a storage medium and includes several instructions for instructing a computer device (which may be a personal computer, a server or a network device) to perform all or some of the steps of the method described in the embodiments of the present disclosure. The foregoing storage medium includes a U disk, a removable hard disk, a read-only memory (ROM), a random-access memory (RAM), a magnetic disk, an optical disk, or other media that can store program codes.

The foregoing embodiments are used for describing, instead of limiting the technical solutions of the present disclosure. Those skilled in the art shall understand that although the present disclosure has been described in detail with reference to the foregoing embodiments, modifications can be made to the technical solutions described in the foregoing embodiments, or equivalent replacements may be made to some technical features in the technical solutions, provided that such modifications or replacements do not cause the essence of corresponding technical solutions to depart from the spirit and scope of the technical solutions of the embodiments of the present disclosure.

1. A method for calculating arc radiation energy of an electric power switch device, comprising:
obtaining a structure, an arc radius, an initial temperature, and an initial pressure of the electric power switch device, and constructing, based on the structure of the electric power switch device, a two-dimensional arc simulation model in two-dimensional axisymmetric geometry by using a fundamental equation of two-dimensional magnetohydrodynamics;
performing iterative calculation in the two-dimensional arc simulation model based on the initial temperature and the initial pressure to obtain temperature data satisfying an iterative constraint condition; and
performing calculation based on the arc radius and the temperature data to obtain first radiation energy of an arc core region and second radiation energy of an arc edge region in the electric power switch device.

2. The method for calculating the arc radiation energy of the electric power switch device according to claim 1, wherein the performing calculation based on the arc radius and the temperature data to obtain first radiation energy of an arc core region and second radiation energy of an arc edge region in the electric power switch device comprises:
performing calculation by using an arc radiation energy calculation equation based on the arc radius and the temperature data to obtain the first radiation energy of the arc core region and the second radiation energy of the arc edge region in the electric power switch device, wherein the arc radiation energy calculation equation is expressed as
$${U}_{0} ( T ) = \frac{2 β {T}^{4}}{R}$$
$$U = {U}_{0} ( T ) K$$
where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

3. The method for calculating the arc radiation energy of the electric power switch device according to claim 2, wherein the reduced pressure coefficient is calculated based on an actual pressure at a position of the arc edge region of the electric power switch device and a pressure at a position of the arc core region of the electric power switch device, and the reduced pressure coefficient is not greater than 1.

4. The method for calculating the arc radiation energy of the electric power switch device according to claim 1, wherein the performing iterative calculation in the two-dimensional arc simulation model based on the initial temperature and the initial pressure to obtain temperature data satisfying an iterative constraint condition comprises:
inputting the initial temperature and the initial pressure into the two-dimensional arc simulation model for calculation to obtain a first pressure of the electric power switch device and an enthalpy value corresponding to the first pressure; and
back-calculating a post-iteration temperature based on the enthalpy value by using a relation equation between temperature and enthalpy h in the two-dimensional arc simulation model;
continuing the iterative calculation until a temperature difference between two temperatures respectively obtained from two adjacent iterative calculations satisfies the iterative constraint condition, and determining a temperature obtained from a last iterative calculation as the temperature data satisfying the iterative constraint condition, wherein
the iterative constraint condition is that the temperature difference is less than a threshold, and the relation equation between temperature and enthalpy h is expressed as
$${{C}_{P} = \frac{\partial h}{\partial T} \vert}_{P}$$
where C_{P} represents a relationship coefficient between the temperature and the enthalpy h, h represent the enthalpy value corresponding to the first pressure, P represents a pressure for the iterative calculation in the two-dimensional arc simulation model, and T represents the temperature data.

5. The method for calculating the arc radiation energy of the electric power switch device according to claim 1, wherein the electric power switch device is implemented by a puffer-type high-voltage circuit breaker or a self-energy high-voltage circuit breaker.

6. An apparatus for calculating arc radiation energy of an electric power switch device, comprising:
a model construction module,
an iterative calculation module, and
an energy calculation module, wherein
the model construction module is configured to obtain a structure, an arc radius, an initial temperature, and an initial pressure of the electric power switch device, and construct, based on the structure of the electric power switch device, a two-dimensional arc simulation model in two-dimensional axisymmetric geometry by using a fundamental equation of two-dimensional magnetohydrodynamics;
the iterative calculation module is configured to perform iterative calculation in the two-dimensional arc simulation model based on the initial temperature and the initial pressure to obtain temperature data satisfying an iterative constraint condition; and
the energy calculation module is configured to perform calculation based on the arc radius and the temperature data to obtain first radiation energy of an arc core region and second radiation energy of an arc edge region in the electric power switch device.

7. The apparatus for calculating the arc radiation energy of the electric power switch device according to claim 6, wherein the energy calculation module is configured to perform calculation by using an arc radiation energy calculation equation based on the arc radius and the temperature data to obtain the first radiation energy of the arc core region and the second radiation energy of the arc edge region in the electric power switch device, wherein the arc radiation energy calculation equation is expressed as
$${U}_{0} ( T ) = \frac{2 β {T}^{4}}{R}$$
$$U = {U}_{0} ( T ) K$$
where T represents the temperature data, K represents a reduced pressure coefficient, β represents a Stefan-Boltzmann constant for the electrical switch device, U₀(T) represents the first radiation energy of the arc core region, U represents the second radiation energy of the arc edge region, and R represents the arc radius of the electric power switch device.

8. The apparatus for calculating the arc radiation energy of the electric power switch device according to claim 7, wherein the reduced pressure coefficient is calculated based on an actual pressure at a position of the arc edge region of the electric power switch device and a pressure at a position of the arc core region of the electric power switch device, and the reduced pressure coefficient is not greater than 1.

9. The apparatus for calculating the arc radiation energy of the electric power switch device according to claim 6, wherein the iterative calculation module comprises: an enthalpy value determination submodule and a temperature data determination submodule, wherein
the enthalpy value determination submodule is configured to input the initial temperature and the initial pressure into the two-dimensional arc simulation model for calculation to obtain a first pressure of the electric power switch device and an enthalpy value corresponding to the first pressure; and
the temperature data determination submodule is configured to back-calculate a post-iteration temperature based on the enthalpy value by using a relation equation between temperature and enthalpy h in the two-dimensional arc simulation model, continue the iterative calculation until a temperature difference between two temperatures respectively obtained from two adjacent iterative calculations satisfies the iterative constraint condition, and determine a temperature obtained from a last iterative calculation as the temperature data satisfying the iterative constraint condition, wherein
the iterative constraint condition is that the temperature difference is less than a threshold, and the relation equation between temperature and enthalpy h is expressed as
$${{C}_{P} = \frac{\partial h}{\partial T} \vert}_{P}$$
where C_{P} represents a relationship coefficient between the temperature and the enthalpy h, h represent an enthalpy value corresponding to the first pressure, P represents a pressure for the iterative calculation in the two-dimensional arc simulation model, and T represents the temperature data.

10. A terminal device, comprising:
a processor, and
a memory, wherein
the memory is configured to store program codes and transmit the program codes to the processor, and
the processor is configured to, when executing instructions in the program codes, perform the method for calculating the arc radiation energy of the electric power switch device according to claim 1.

11. A terminal device, comprising:
a processor, and
a memory, wherein
the memory is configured to store program codes and transmit the program codes to the processor, and
the processor is configured to, when executing instructions in the program codes, perform the method for calculating the arc radiation energy of the electric power switch device according to claim 2.

12. A terminal device, comprising:
a processor, and
a memory, wherein
the memory is configured to store program codes and transmit the program codes to the processor, and
the processor is configured to, when executing instructions in the program codes, perform the method for calculating the arc radiation energy of the electric power switch device according to claim 3.

13. A terminal device, comprising:
a processor, and
a memory, wherein
the memory is configured to store program codes and transmit the program codes to the processor, and
the processor is configured to, when executing instructions in the program codes, perform the method for calculating the arc radiation energy of the electric power switch device according to claim 4.

14. A terminal device, comprising:
a processor, and
a memory, wherein
the memory is configured to store program codes and transmit the program codes to the processor, and
the processor is configured to, when executing instructions in the program codes, perform the method for calculating the arc radiation energy of the electric power switch device according to claim 5.
